(19) United States
(12) Patent Application Publication
(10) Pub. No.: US 2007/0194605 A1
(43) Pub. Date: Aug. 23, 2007

(54) Cross member or structural component for a motor vehicle

(75) Inventors: Christian Merkle, Pluderhausen (DE); Walter Wolf, Oppenweiler-Zell (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/592,507

(22) PCT Filed: Mar. 16, 2005
(86) PCT No.: PCT/EP05/02791

§ 371 Date: Sep. 12, 2006

(30) Foreign Application Priority Data
Mar. 17, 2004 (DE) 10 2004 013 384.0

(51) Int. Cl. B62D 25/00

(52) U.S. Cl. 296/193.02

(57) ABSTRACT

The invention relates to a cross member (1), in particular for a motor vehicle. The central region of said cross member (1) has a first cross-section with a first surface area and a first circumference and at least one of: the two end regions comprises a second cross-section with a second surface area and a second circumference. the ratio of the first surface area to the first circumference is greater than the ratio of the second surface area to the second circumference.

The invention relates to a cross member or a structural component for a motor vehicle according to the precharacterizing clause of claim 1. DE 102 21 654 A1 discloses a cross member for a motor vehicle, comprising an upper half shell and a lower half shell which, at their mutually facing ends, have tabs which are adhesively bonded to each other by an adhesive. To secure elements, such as, for example, the steering column, a holder is fastened to the cross member by means of a plurality of screws. The screws are adhesively bonded after being screwed.

A reinforcement, designed as a tube, can be attached to the cross member, with it being possible for the tube to be changed in its cross section at its ends for the purpose of simplifying the attachment to the cross member.

Furthermore, cross members or other structural components are known to which holders are welded or are attached in another manner. As a consequence of doubling the material, the weight is increased and the additional working step leads to an increase of the production costs.

However, cross members of this type leave something to be desired, in particular with regard to the weight and the rigidity of the connecting point.

It is the object of the invention to provide an improved cross member.

This object is achieved by a cross member or a structural component with the features of claim 1. Advantageous refinements are the subject matter of the subclaims. For the sake of simplicity, reference is made in this respect below just to a cross member, but a correspondingly designed element may also be used at other locations as another structural component.

According to the invention, a cross member is provided which has a first cross section with a first area and a first circumference in a central region, and a second cross section with a second area and a second circumference in at least one of its two end regions, the ratio of first area to first circumference being greater than the ratio of second area to second circumference. In this case, the cross member is preferably of flattened design in at least one of its end regions and/or is of wider design than in its central region. A configuration of this type forms a connecting point which is stiff with regard to torque. The production can take place in a simple manner by means of deformation. The deformation can preferably take place by means of deep-drawing, embossing using shaping dies, internal or external high-pressure deformation, magnet deformation with simultaneous molding in of supporting elements, such as, for example, sleeves, or hammering. A configuration of this type provides great freedom in terms of design with good integration capacity. The number of components can be kept low, with it being possible for one or more media-conducting channels to be integrated and/or for the cavities to be used as cable channels. This permits cost-effective production.

The cross member is preferably formed by two half shells which are connected to each other in a known manner. In this case, stiffening elements can be provided in one or both half shells.

The half shells are preferably extruded or rolled profiles which have a continuous profile in the undeformed state and of which at least one is deformed at least in one of its end regions.

To maintain a distance between the wall regions of the cross member in its deformed end region, at least one supporting body is arranged in the interior of the cross member, preferably in the undeformed end region, with, in particular, at least one screw penetrating the cross member and the supporting body arranged therein. The supporting body is preferably formed by a sleeve, but other configurations are also possible.

In at least one end region, two or more depressions which extend in the longitudinal direction of the cross member and protrude into the interior of the cross member are preferably provided on at least one of the two flattened sides of the cross member. Said depressions permit optimum stiffening and provide good possibilities of attachment.

The cross member can have ribs, preferably at least four ribs, running in the longitudinal direction to increase the rigidity.

At least one cavity through which a medium, such as, for example, air, passes is preferably provided in the cross member, so that the cross member forms part of the motor vehicle ventilation system and additional construction space for air ducts is not required.

To increase the rigidity, the cross member can have stiffening elements in its interior, for example a plastic structure, preferably with ribs running crosswise or a honeycomb-like structure. This can be injected in a relatively simple manner and significantly increases the rigidity with relatively little weight. Despite the stiffening elements, channels for a medium to pass through can be provided in the interior of the cross member.

The invention is explained in detail below using a plurality of exemplary embodiments, some with variants, with reference to the drawing, in which:

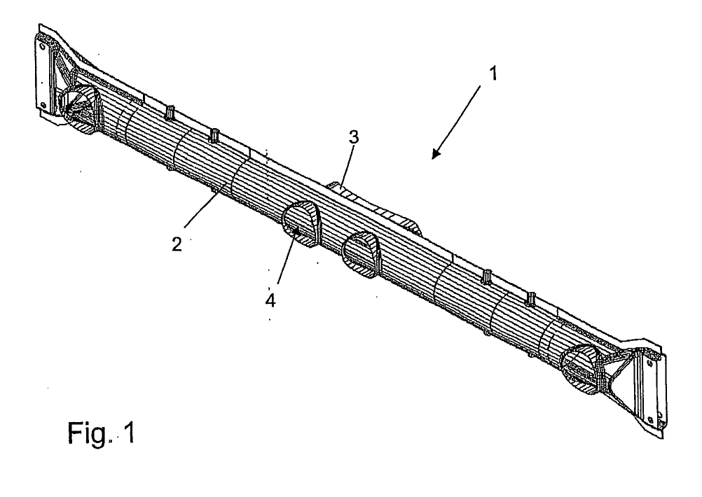

FIG. 1 shows a perspective view of a cross member according to the first exemplary embodiment, without attachments,

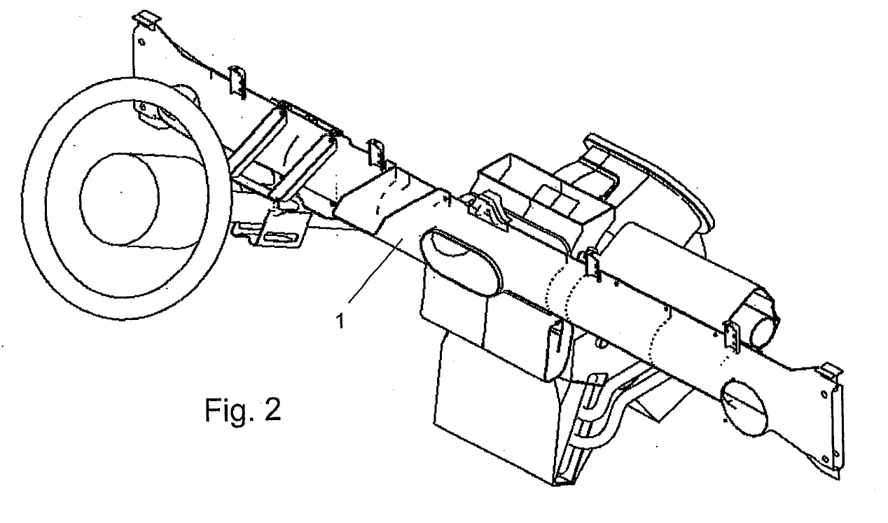

FIG. 2 shows a perspective view of the cross member of FIG. 1 with elements attached thereto,

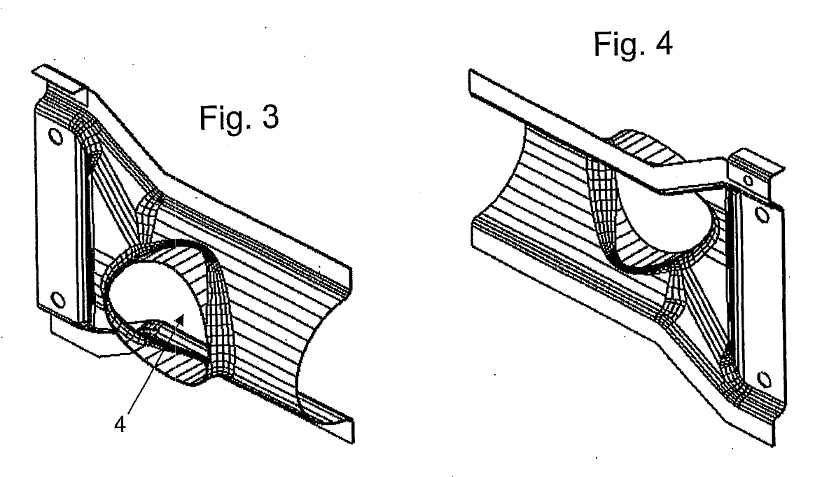

FIG. 3 shows a perspective detailed view of an end region of a half shell of the cross member of FIG. 1,

FIG. 4 shows another perspective detailed view of the end region illustrated in FIG. 3,

FIG. 5 shows a perspective detailed view of an end region of the other half shell of the cross member of FIG. 1,

FIG. 6 shows another perspective detailed view of the end region illustrated in FIG. 5,

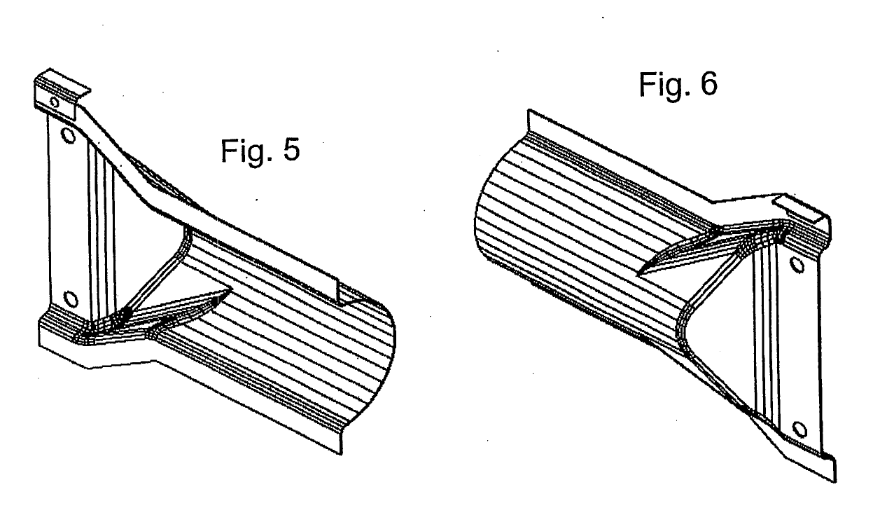

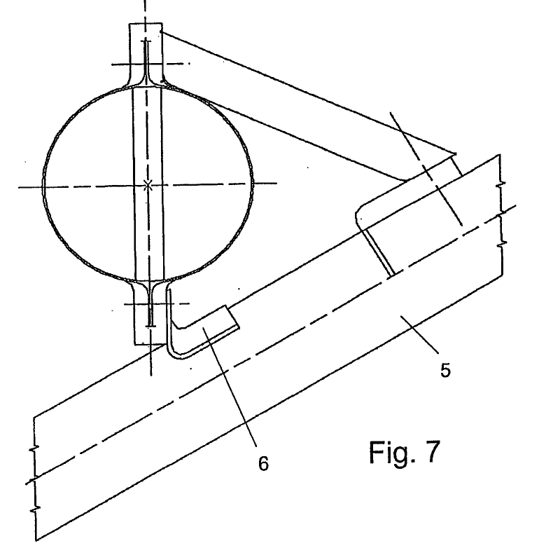

FIG. 7 shows a section through the cross member of FIG. 1,

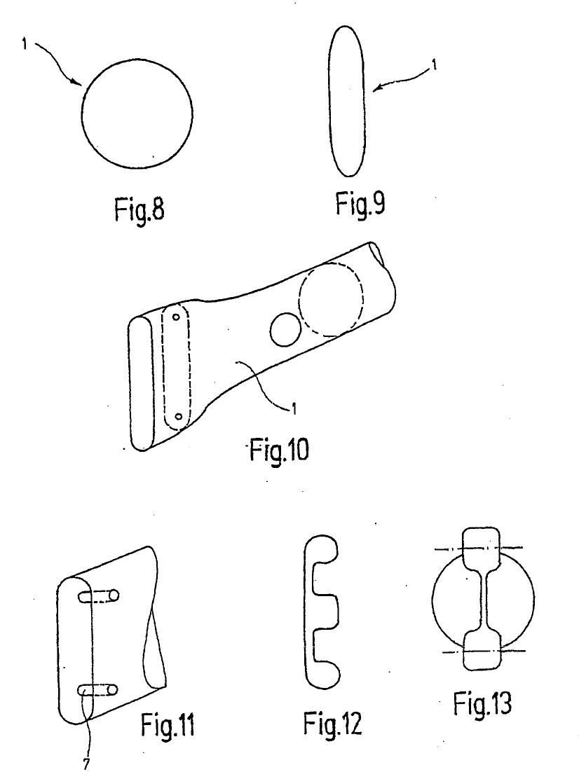

FIG. 8 shows a section through an end region of a cross member according to the second exemplary embodiment before the deforming operation,

FIG. 9 shows a section corresponding to FIG. 8 through the cross member after the deforming operation,

FIG. 10 shows a perspective view of the end region of the cross member according to the second exemplary embodiment,

FIG. 11 shows a variant of the second exemplary embodiment with supporting bodies,

FIG. 12 shows a section through the end region of a cross member according to the third exemplary embodiment,

FIG. 13 shows a section through the end region of a cross member according to the fourth exemplary embodiment,

FIG. 14 shows a section through an end region of a cross member according to the fifth exemplary embodiment before the deforming operation,

FIG. 15 shows a perspective view of the end region of FIG. 14 after the deforming operation,

FIG. 16 shows a section through an end region of a cross member according to the sixth exemplary embodiment before the deforming operation,

FIG. 17 shows a section through the end region of FIG. 16 after the deforming operation;

FIG. 18 shows a section through the end region of a cross member according to the seventh exemplary embodiment,

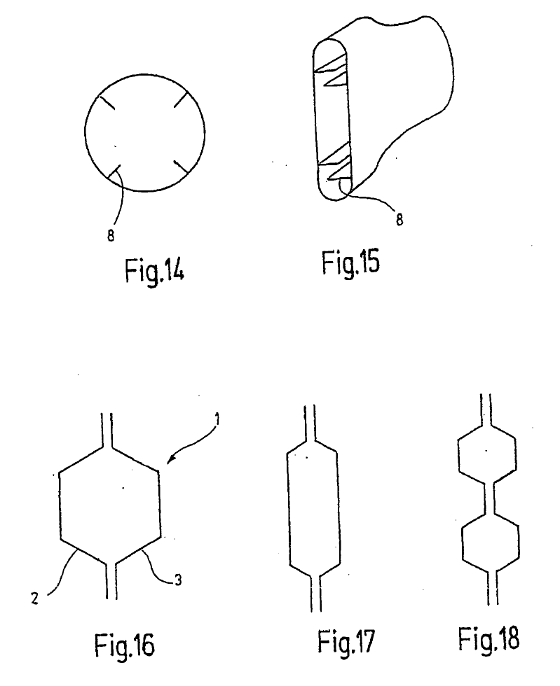

FIG. 19 shows a plan view of a first hollow-cylindrical supporting element,

FIG. 20 shows a plan view of a second hollow-cylindrical supporting element,

FIG. 21 shows a perspective view of a third supporting element,

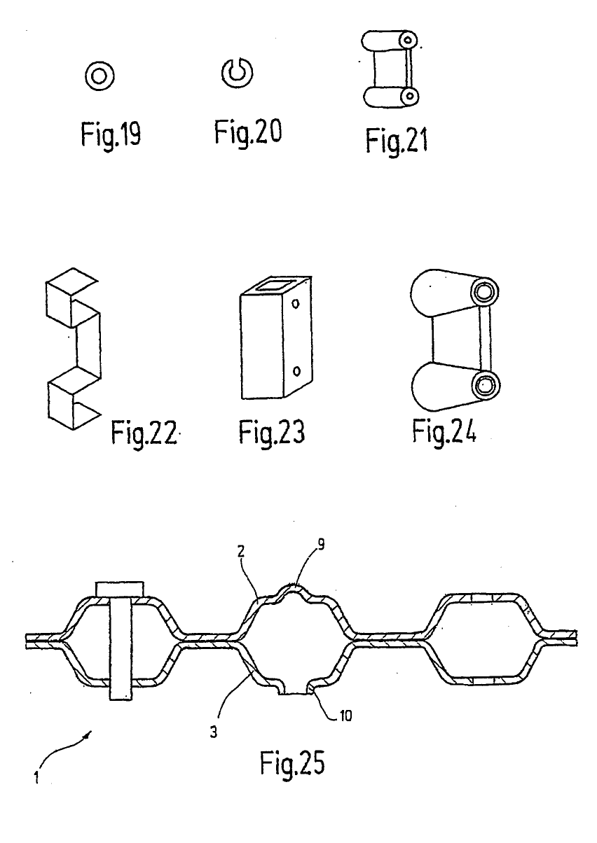

FIG. 22 shows a perspective view of a fourth supporting element,

FIG. 23 shows a perspective view of a fifth supporting element,

FIG. 24 shows a perspective view of a sixth supporting element, and

FIG. 25 shows a section through an end region of a cross member with a screw being illustrated.

According to the first exemplary embodiment, a cross member 1 of a motor vehicle with integrated air conduction is formed by a first half shell 2 and a second half shell 3. These each involve a metal structure which is produced by means of deep-drawing or extrusion and subsequent machining, with, inter alia, the ends on the longitudinal side being deformed. In the case of extrusion, the cross member is preferably of single-part design. Edges which in each case protrude outward are provided on the longitudinal sides of the half shells 2 and 3, which edges are brought into contact with one another and are joined together in a known manner. According to the present exemplary embodiment, the interior between the two half shells 2 and 3 is of hollow design, so that the passing of air through it is possible. Part of the ventilation system is therefore integrated into the cross member 1. Instead of or in addition to air, other media can also be conducted through the cross member 1. The cross member 1 has openings 4 arranged transversely to its longitudinal extent to conduct air in and out. Furthermore, further elements are attached to the cross member 1, as illustrated in FIG. 2.

FIG. 7 shows the region of the steering column 5. In this case, the connection between the steering column 5 and the cross member 1 takes place by means of extruded profiles 6 which are attached to the parts to be connected, in the present case by means of screw connections.

As a consequence of the deforming operation, the ends of the cross member 1 are of widened design, so that they serve as a stiffening element. This results in the ratio of a first area and a first circumference in a central cross section being smaller than the ratio of a second area and a second circumference in the two end regions. The widened configuration of the end regions permits a connection which is stiff with regard to torque.

According to a variant which is not illustrated in the drawing, the half shells have a cross rib-like plastic structure, as described for example, in DE 100 65 219 C1 or DE 101 25 559 A1. The plastic structure is injected onto the particular metal structure and serves to stiffen the cross member. Otherwise, the configuration of the cross member corresponds to that of the previously described first exemplary embodiment.

FIG. 8 shows the cross section of an end region of a tubular extruded profile, which forms a cross member 1 according to the second exemplary embodiment, before deformation and FIG. 9 shows it after deformation. The central, significantly larger region of the cross member 1 remains unchanged in its circular cross section. Each of the two end regions has two straight regions running essentially parallel to each other and two regions connecting the straight regions in a radius, with the result that, in turn, the ratio of a first area and a first circumference in a central cross section of the cross member 1 is smaller than the ratio of a second area and a second circumference in the two end regions. The widened and flattened configuration of the end regions permits, according to the first exemplary embodiment, a connection which is stiff with regard to torque.

To limit a deformation of the end regions due to excessive action of force, for example by installation screws, according to the variant of the second exemplary embodiment that is illustrated in FIG. 11, supporting bodies 7 are provided, in the present case in the form of sleeves, which are arranged in the interior of the cross member 1 as an extension of installation holes which are provided in the end regions for the purpose of attaching the cross member 1. The shape of the cross member 1 corresponds to that of the previously described second exemplary embodiment.

FIG. 12 shows the cross section of a widened and flattened end region of a cross member 1 according to the third exemplary embodiment. The starting material for this corresponds to the extruded profile illustrated in FIG. 8. The latter is also deformed in both end regions-of the cross member 1 in such a manner that the ratio of a first area and a first circumference in a central cross section of the cross member 1 is smaller than the ratio of a second area and a second circumference in the two end regions. In this case, in the two end regions, two depressions which extend in the longitudinal direction of the cross member 1 and protrude into the interior of the cross member 1 are provided on in each case one of the two flattened sides and serve to increase the rigidity.

FIG. 13 shows the end region of a cross member 1 according to the fourth exemplary embodiment which, by means of deformation starting from a hollow-cylindrical profile obtained in the central region of the cross member 1, is of flattened design in such a manner that two cavities are formed at the outer ends of each end region, said cavities being divided by a region in which the two side walls are of rectilinear design and bear against each other.

FIG. 14 shows an extruded profile in tubular form with inwardly extending ribs 8 running in the longitudinal direction. Said extruded profile is deformed to form the end regions of the cross member 1 according to the second exemplary embodiment, thus resulting in the configuration illustrated in FIG. 15. With appropriate deformation, the ribs 8 can serve at the same time as the supporting elements which ensure a minimum distance between the walls and prevent the statics from collapsing during the screwing of a component. Furthermore, given an appropriate configuration of the ribs 8, the latter can also serve as air-conducting elements and/or to position lines running in the cross member 1. In this case, screw fastening for the cross member 1 are arranged in particular approximately centrally between two ribs 8 arranged on mutually opposite sides.

According to a modification not illustrated in the drawing, just two ribs are provided which, in the deformed state, are arranged adjacent to the screw fastening in the corresponding end region. In this case, the screw fastening is arranged in particular as closely adjacent as possible between rib and narrow side of the end region, so that supporting elements can be omitted.

The sixth and seventh exemplary embodiment relate to a cross member 1 comprising two trough-like half shells 2 and 3 with outwardly extending edges running in the longitudinal direction. The half shells 2 and 3 are composed of in each case a rolled profile or deep-drawing parts. FIG. 16 shows in this respect the undeformed central region of the particular cross member 1 which is of hexagonal design with approximately identical side lengths (honeycomb-like).

According to the sixth exemplary embodiment illustrated in FIG. 17, the end regions are deformed in such a manner that the bottom surfaces of the half shells 2 and 3 are arranged closer to each other than in the undeformed state, but there is still a distance between the bottom surfaces.

According to the seventh exemplary embodiment illustrated in FIG. 18, the end regions are deformed in such a manner that two honeycomb-like regions are formed which are somewhat spaced apart from each other.

In both cases, the end regions are of flattened and widened design, so that these regions are stiffened.

Various supporting elements serving to maintain distance, in particular in the case of cross members comprising two half shells, are explained in more detail below with reference to FIGS. 19 to 24. FIG. 19 shows a plan view of a first supporting element which is of hollow-cylindrical design and has a closed profile, as can be produced, for example, by means of severing a continuous tubular profile, and FIG. 20 shows a plan view of a second supporting element of hollow-cylindrical design with a profile which is open on one side.

FIG. 21 shows a supporting element which is designed for two supporting points. In this case, two closed hollow-cylindrical regions are connected via a continuous intermediate region, so that the intermediate region can fulfill an additional stiffening function. FIG. 22 shows a supporting element which is likewise suitable for two supporting points, it being a laterally open profile which is held between the inner walls of the cross member merely by means of the tightening of the screws. To receive the screws, two U-shaped regions are provided in this part which is designed, for example, as an extruded element, rolled profile section, or beveled or bent part. FIG. 23 shows a square profile with holes running transversely to receive the screws, which square profile serves as the supporting element. FIG. 24 shows a cast part which corresponds to the supporting element of FIG. 21. This can be, for example, a pure plastic part or a plastic part in which two metal sleeves are injected. Furthermore, further functions may be integrated into components of this type, such as, for example, the deflecting of the air to side outlets.

FIG. 25 shows a section through an end region of a cross member 1, which has three cavities which extend in the longitudinal direction of the cross member 1 and are separated from one another by bearing regions of the two half shells 2 and 3 forming the cross member 1. In the region of the two outer cavities, holes are provided through which a respective screw serving for the fastening is inserted (only illustrated on the left). The half shell 2 is provided in the central region with an index 9 in knob form and the half shell 3 is provided with an index 10 in the form of an eyelet.

The flanks of the lateral cavities in the end regions should be as steep as possible and should be only at a small distance from the adjacent screw. As a result, the lateral walls to the left and right of the screw can take on the function of the supporting body, so that, if appropriate, supporting elements, as illustrated in FIGS. 19 to 24, can be omitted. A somewhat longer screw results in better securing of the connection than with a thin flange and short screw.

### List of Reference Numbers

1 Cross member
2 First half shell
3 Second half shell
4 Opening
5 Steering column
6 Extruded profile
7 Supporting body
8 Rib
9 Index
10 Index

1. A cross member in particular for a motor vehicle, the cross member having a first cross section with a first area and a first circumference in a central region, and having a second cross section with a second area and a second circumference in at least one of its two end regions, wherein the ratio of first area of first circumference is greater than the ratio of second area to second circumference.

2. The cross member as claimed in claim 1, wherein the cross member is of flattened design in at least one of its end regions.

3. The cross member as claimed in claim 1, wherein the cross member is of wider design in at least one of its end regions than in its central region.

4. The cross member as claimed in claim 1, wherein the cross member has two half shells which are connected to each other.

5. The cross member as claimed in claim 4, the half shells are deep-drawn, extruded or rolled profiles of which at least one is deformed at least in one of its end regions.

6. The cross member as claimed in claim 1, wherein, in at least one end region, at least one supporting body is arranged in the interior of the cross member.

7. The cross member as claimed in claim 6, wherein the supporting body is formed by a sleeve.

8. The cross member as claimed in claim 1, wherein, in at least one end region, two or more depressions which extend in the longitudinal direction of the cross member and protrude into the interior of the cross member are provided on at least one of the two flattened sides of the cross member.

9. The cross member as claimed in claim 1, wherein, in at least one end region, flanks are provided on both sides of the two flattened sides of the cross member and are arranged at an angle of approx. 80 to 100° to the flattened sides.

10. The cross member as claimed in claim 1, wherein the cross member has ribs running in the longitudinal direction.

11. The cross member as claimed in claim 10, wherein the cross member has at least two, in particular precisely two or precisely four, ribs.

12. The cross member as claimed in claim 1, wherein the cross member has a cavity through which a medium passes.

13. The cross member as claimed in claim 1, wherein the cross member has stiffening elements in its interior.

14. The cross member as claimed in claim 13, wherein the stiffening elements are formed by at least one plastic structure.

15. The cross member as claimed in claim 13, wherein the stiffening elements are formed by ribs running crosswise or by honeycomb-like structures.
